(19) United States
(12) Patent Application Publication
(10) Pub. No.: US 2025/0118027 A1
(43) Pub. Date: Apr. 10, 2025

(54) FACE MICRO DETAIL RECOVERY VIA PATCH SCANNING, INTERPOLATION, AND STYLE TRANSFER

(71) Applicants: DISNEY ENTERPRISES, INC., Burbank, CA (US); ETH Zürich (Eidgenössische Technische Hochschule Zürich), Zürich (CH)

(72) Inventors: Derek Edward BRADLEY, Zürich (CH); Sebastian Klaus WEISS, Zürich (CH); Prashanth CHANDRAN, Zürich (CH); Gaspard ZOSS, Zürich (CH); Jackson Reed STANHOPE, Zürich (CH)

(21) Appl. No.: 18/906,639

(22) Filed: Oct. 4, 2024

Related U.S. Application Data
(60) Provisional application No. 63/587,936, filed on Oct. 4, 2023.

(51) Int. Cl. G06T 19/00; G06T 15/04; G06T 17/20

(52) U.S. Cl. CPC G06T 19/00; G06T 15/04; G06T 17/20

(57) ABSTRACT

The present invention sets forth a technique for performing face micro detail recovery. The technique includes generating one or more skin texture displacement maps based on images of one or more skin surfaces. The technique also includes transferring, via one or more machine learning models, stylistic elements included in the one or more skin texture displacement maps onto one or more regions included in a modified three-dimensional (3D) facial reconstruction. The technique further includes generating a final 3D facial reconstruction that includes structural elements included in the 3D facial reconstruction and the stylistic elements included in the one or more skin texture displacement maps.

### CROSS-REFERENCE TO RELATED APPLICATIONS

This application claims priority benefit to the U.S. provisional application titled “TECHNIQUES FOR DETERMINING FACIAL MICRO DETAILS,” filed on Oct. 4, 2023, and having Ser. No. 63/587,936. This related application is also hereby incorporated by reference in its entirety.

### BACKGROUND

### Field of the Various Embodiments

Embodiments of the present disclosure relate generally to machine learning and generative modeling and, more specifically, to techniques for performing face micro detail recovery.

### Description of the Related Art

The accurate representation of facial micro details, including wrinkles and other skin texture, is an important step in creating, rendering, and animating digital avatars and other three-dimensional (3D) character representations. A digital avatar may be a static representation of a character as a still image or a dynamic representation of a user in, e.g., a chat, telepresence, or entertainment application. Accurately modeling facial micro details provides a digital avatar with a more natural and organic appearance, rather than an overly smooth or plastic appearance. Realistic micro details are of particular importance in high-end visual productions, where extreme close-up shots are common.

Existing techniques for representing facial micro details may uniformly apply one or more generated noise patterns to an avatar's skin. The applied noise pattern modifies the uniform representation of skin texture to simulate micro details in the skin. These techniques are generally computationally simple and may be suitable for real-time modification of a digital avatar.

One drawback of noise-based texture modification is that the uniformly applied noise patterns do not include sufficient structure to accurately model or simulate micro details, such as wrinkles. Wrinkles may include a structural directionality characteristic, such as a horizontal, vertical, or other orientation, and may also have a finite length determined by defined endpoints. Uniform noise patterns may not adequately address these structural characteristics. Further, noise-based texture modifications may not provide sufficient realism and may therefore be inadequate for generating close-up representations of an avatar's skin.

Other existing techniques may include a graph-based simulation approach that represents facial micro details, such as pores and wrinkles, as nodes and edges in a wrinkle graph. The techniques simulate one or more skin textures based on the wrinkle graph.

While simulating skin textures based on a wrinkle graph provides a high degree of user control and is suitable for generating micro details, the resulting skin textures may appear artificial or synthetic, and may fail to represent the organic chaotic variations in pore distribution and wrinkle shape that are present in real skin.

Still other existing techniques may capture realistic depictions of actual skin patches via sophisticated scanning techniques and extend these captured skin patches over an entire facial representation via one or more texture synthesis methods. These techniques may generate organic, natural-appearing skin textures, including micro details.

One drawback of the scan-based techniques is that the scanning apparatus may be expensive, complicated, or require significant configuration or tuning. The texture synthesis methods may also be highly dependent on the accuracy of a 3D facial reconstruction to which the synthetic textures are applied. Further, the texture synthesis methods may provide little or no opportunity for artistic user input when extending the captured skin patches over the 3D facial reconstruction.

As the foregoing illustrates, what is needed in the art are more effective techniques for performing face micro detail recovery.

### SUMMARY

One embodiment of the present invention sets forth a for performing face micro detail recovery. The technique includes generating one or more skin texture displacement maps based on images of one or more skin surfaces and transferring, via one or more machine learning models, stylistic elements included in the one or more skin texture displacement maps onto one or more regions included in a modified three-dimensional (3D) facial reconstruction. The technique also includes generating a final 3D facial reconstruction that includes structural elements included in the 3D facial reconstruction and the stylistic elements included in the one or more skin texture displacement maps.

One technical advantage of the disclosed techniques relative to the prior art is that the disclosed techniques simultaneously provide both artistically controllable skin simulation and realistic, organic results based on style transfer from high-resolution captures of actual skin samples onto the simulated skin features. Further, the disclosed techniques are operable to capture skin samples via a simple and inexpensive camera-based scanning apparatus. These technical advantages provide one or more improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments of the present invention.

FIG. 2 is a representation of the data flow between various components of the present invention, according to some embodiments.

FIG. 3 is a more detailed illustration of the capture engine of FIG. 1, according to some embodiments.

FIG. 4 is a flow diagram of method steps for capturing skin samples, according to some embodiments.

FIG. 5 is a more detailed illustration of the simulation engine of FIG. 1, according to some embodiments.

FIG. 6 is a flow diagram of method steps for generating simulated skin textures, according to some embodiments.

FIG. 7 is a more detailed illustration of the transfer engine of FIG. 1, according to some embodiments.

FIG. 8 is a flow diagram of method steps for performing style transfer, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

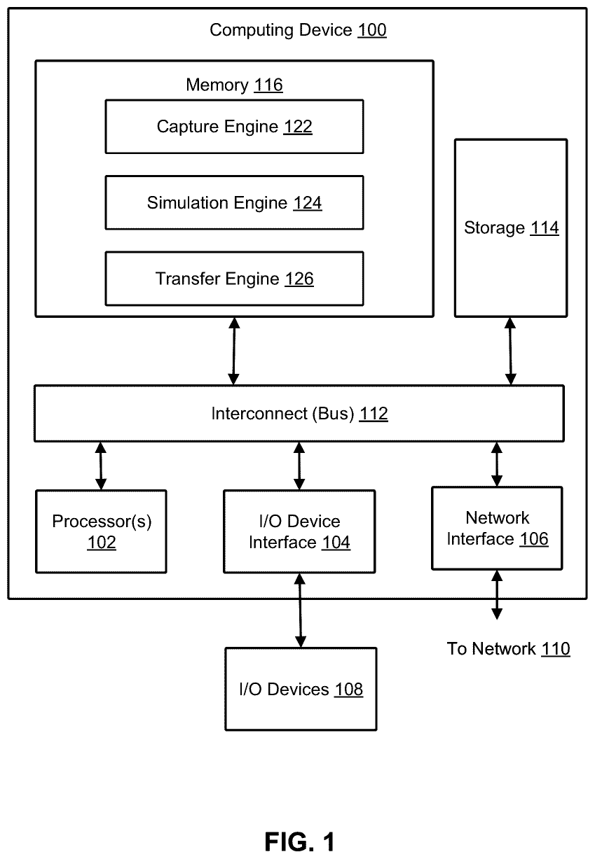

FIG. 1 illustrates a computing device 100 configured to implement one or more aspects of various embodiments of the present invention. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a capture engine 122, a simulation engine 124, and a transfer engine 126 that reside in a memory 116.

It is noted that the computing device described herein is illustrative and that any other technically feasible configurations fall within the scope of the present disclosure. For example, multiple instances of capture engine 122, simulation engine 124, or transfer engine 126 could execute on a set of nodes in a distributed and/or cloud computing system to implement the functionality of computing device 100. In another example, capture engine 122, simulation engine 124, or transfer engine 126 could execute on various sets of hardware, types of devices, or environments to adapt capture engine 122, simulation engine 124, or transfer engine 126 to different use cases or applications. In a third example, capture engine 122, simulation engine 124, or transfer engine 126 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Capture engine 122, simulation engine 124, and transfer engine 126 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including capture engine 122, simulation engine 124, or transfer engine 126.

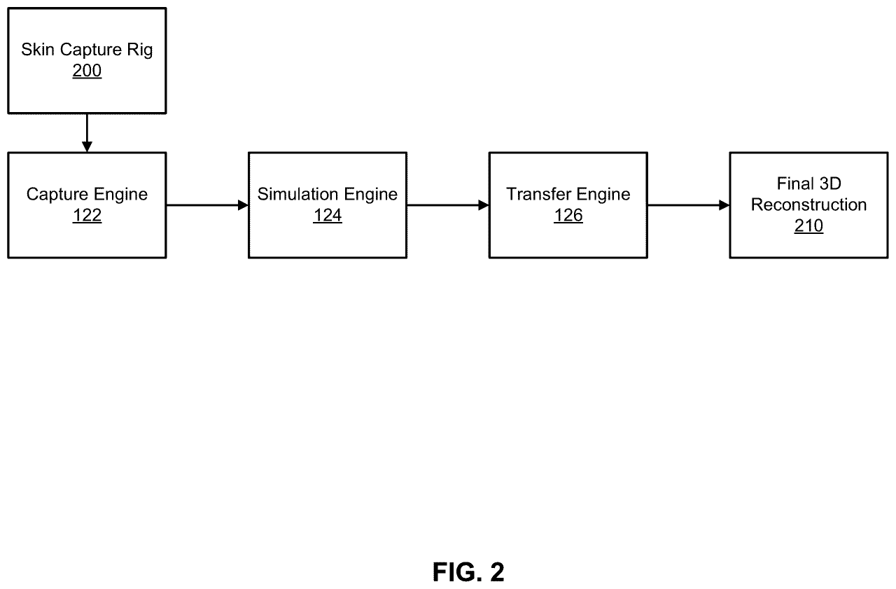

FIG. 2 is a representation of the data flow between various components of the present invention, according to some embodiments. As shown, the various components include, but are not limited to, skin capture rig 200, capture engine 122, simulation engine 124, and transfer engine 126. The present invention generates final 3D reconstruction 210.

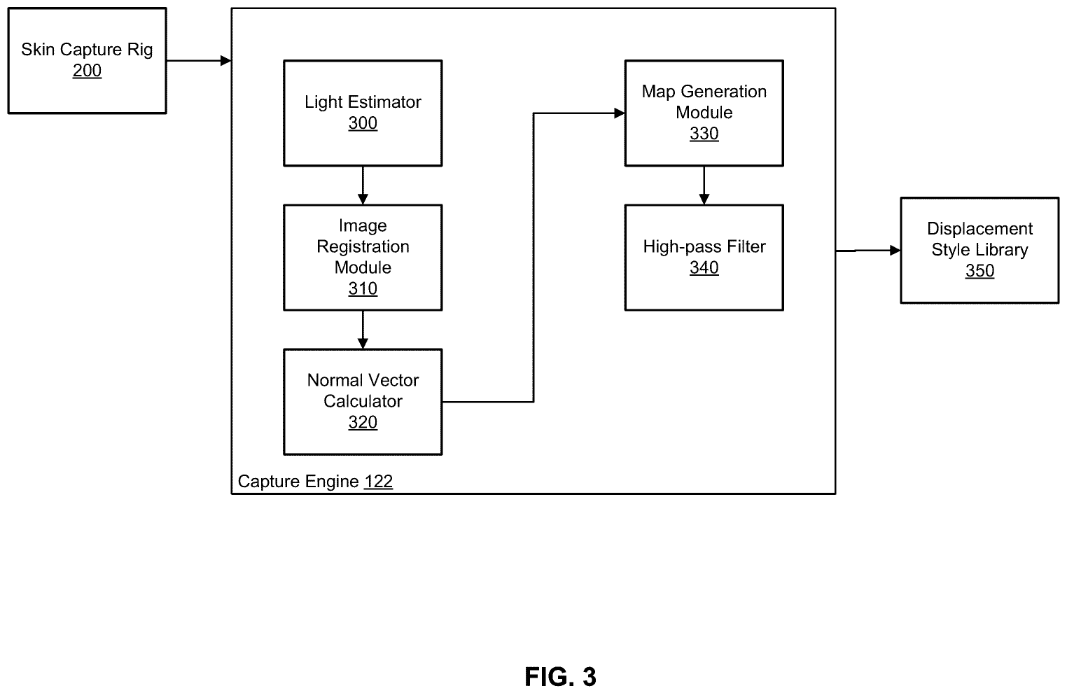

Skin capture rig 200 includes an arrangement of multiple cameras, multiple reflective spheres, and a movable light source. Skin capture rig 200 further includes a vertical planar surface having a window cutout against which a human subject may place a portion of their face, such as a cheek, forehead, temple, or nose. Skin capture rig 200 records multiple images of a skin surface placed against the window cutout, where each image is illuminated by the movable light source from one of various different light positions. For example, skin capture rig 200 may capture thirty images of a skin surface with thirty different corresponding light positions. Skin capture rig 200 is described in greater detail in the description of FIG. 3 below.

Capture engine 122 retrieves images captured by skin capture rig 200 and generates a displacement style library based on the captured images. For each captured image, capture engine 122 estimates a position for the movable light source based on multiple captured reflections of the light source visible in the reflective spheres included in skin capture rig 200. Based on the position of the light source and the position of a camera included in skin capture rig 200, capture engine 122 calculates a normal vector for one or more pixels in each of the captured image and generates a displacement map describing the shape of the captured skin patch, including fine organic and/or chaotic variations in the skin patch. Capture engine 122 generates metadata associated with each skin patch, such as the age or gender of the human subject, and a location of the skin patch on the subject's face, e.g., forehead, cheek, or chin. Capture engine 122 stores the generated displacement maps and associated metadata in a displacement style library. In subsequent steps, the disclosed techniques may generate one or more skin simulator presets based on the displacement style library. The disclosed techniques may also perform style transfer from one or more displacement maps included in the displacement style library onto a simulated skin texture included in a 3D face reconstruction. Capture engine 122 is discussed in greater detail in the description of FIG. 3 below.

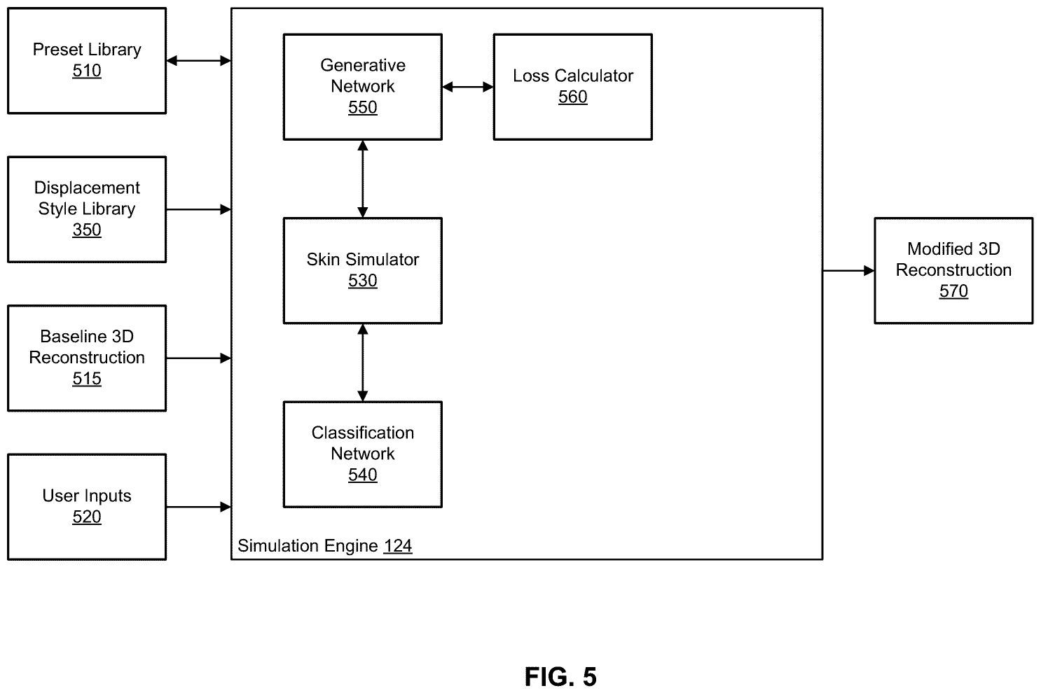

Simulation engine 124 generates and applies skin textures to a baseline 3D face reconstruction via a skin simulator, based on one or more sets of skin simulator parameters included in preset library. The 3D face reconstruction may include a representation of a human face expressed as, e.g., a 3D mesh of triangles or other polygons. The 3D reconstruction may include macro-level details of the face, such as eyes, nose, mouth, or eyebrows. The preset library may include a variety of skin types and a set of skin simulator parameters associated with each skin type. Simulation engine 124 may also generate new entries in the preset library based on displacement style library entries generated by capture engine 122. A user may select one of the skin types from the preset library and designate a portion of the 3D face reconstruction to which to apply the selected skin type. The user may apply different skin types from the preset library to multiple different portions of the 3D face reconstruction. Simulation engine 124 may interpolate skin simulator values included in the different selected skin types across the entire 3D face reconstruction, including portions of the 3D face reconstruction for which the user did not manually apply a skin texture from the preset library. Via a skin simulator, simulation engine 124 generates skin textures for the entire 3D face reconstruction and transmits the modified 3D face reconstruction to transfer engine 126. Simulation engine 124 is discussed in greater detail in the description of FIG. 5 below.

Transfer engine 126 performs style transfer to apply natural-appearing small-scale skin variations based on the images of real skin patches captured by capture engine 122 to the modified 3D face reconstruction generated by simulation engine 124. Style transfer applies stylistic elements, such as colors, textures, or lighting characteristics, from an input style image to the content and structure of an input content image. For example, given a style image including a depiction of an impressionist painting and a content image including a depiction of a building, a style transfer technique may generate a depiction of the building included in the content image as modified with one or more stylistic elements included in the impressionist painting.

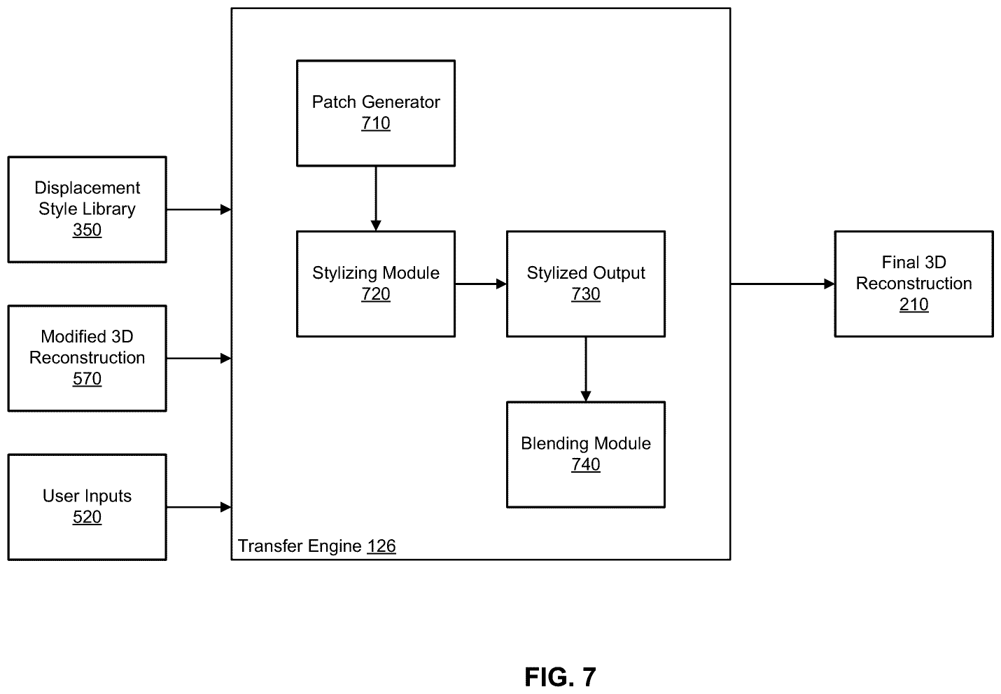

Transfer engine 126 performs style transfer from one or more displacement maps included in the displacement style library onto one or more skin patches designated in the modified 3D reconstruction generated by simulation engine 124. The one or more displacement maps serve as input style images, while the one or more skin patches serve as input content images. Transfer engine 126 may transfer a style from one displacement map onto multiple skin patches. Transfer engine may also transfer different styles from multiple different displacement maps onto multiple different skin patches included in the modified 3D reconstruction. Transfer engine 126 generates a final 3D reconstruction 210 that includes the simulated skin textures generated by simulation engine 124 as modified with the high-frequency details and organic skin variations captured by capture engine 122. Transfer engine 126 is discussed in greater detail in the description of FIG. 7 below.

FIG. 3 is a more detailed illustration of capture engine 122 of FIG. 1, according to some embodiments. Capture engine 122 processes high-resolution images of one or more skin patches generated via skin capture rig 200 and generates displacement style library 350 based on the images. Capture engine 122 includes, without limitation, light estimator 300, image registration module 310, normal vector calculator 320, map generation module 330, and high-pass filter 340.

Skin capture rig 200 includes an arrangement of multiple cameras, multiple reflective spheres, and a movable light source. Skin capture rig 200 further includes a vertical planar surface having a window cutout against which a human subject may place a portion of their face, such as a cheek, forehead, temple, or nose. Skin capture rig 200 records multiple images of a skin surface placed against the window cutout, where each image is illuminated by the movable light source from one of various different light positions. For example, skin capture rig 200 may capture thirty images of a skin surface with thirty different corresponding light positions.

In various embodiments, skin capture rig 200 may include a single main camera and two side cameras. The single main camera may be aligned to capture an image of a skin surface placed against the window cutout included in the vertical planar surface. Skin capture rig 200 may also include two reflective spheres positioned below and to the left and right sides of the window cutout. The two side cameras may be placed on the left and right sides of the main camera, with each side camera oriented to capture images of the two reflective spheres. The main and side cameras may be triggered simultaneously to generate an image of a skin surface and two associated images of the reflective spheres. All three camera positions are calibrated in a single 3D world space. The positions and sizes of the reflective spheres are also reconstructed in 3D by annotating their projections in the side cameras and using their known diameters to triangulate their 3D positions.

In various embodiments, the movable light source included in skin capture rig 200 may include a handheld flashlight. Based on reflections of the movable light source present on the surfaces of the reflective spheres and captured by the side cameras, capture engine 122 may calculate, via light estimator 300 discussed below, a 3D location of the movable light source associated with each of multiple captured images of the skin surface.

Light estimator 300 calculates, for each captured image of a skin surface, a location associated with the movable light source. For each image generated by one side camera, e.g., the left-side camera, light estimator 300 analyzes the image and, via any suitable highlight detection technique, identifies the two pixels included in the image that are most likely to represent the highlight reflections of the movable light source in the two reflective spheres captured by the side camera. Light estimator 300 repeats the highlight detection technique with an image generated by the other side camera, e.g., the right-side camera, to identify two additional pixels that are most likely to represent the highlight reflections of the movable light source in the two reflective spheres captured by the other side camera. Light estimator 300 projects these four identified highlight reflections into 3D space and calculates four intersection points on the reflective spheres. Light estimator 300 calculates reflections associated with these four intersection points and generates four rays that converge at or near the location of the movable light source in 3D space. Due to imprecision in the highlight detection technique, the four generated light rays may not converge at a single point. In these instances, light estimator 300 may calculate a point in 3D space that minimizes the distances between the calculated point and the four light rays. Light estimator 300 associates the estimated light position with the image of the skin surface captured by the main camera.

Image registration module 310 aligns multiple captured images of a single skin surface generated by the main camera discussed above. Aligning the captured images reduces spatial inconsistencies between the multiple images caused by subject motion, small skin movements resulting from the subject's breathing, or small skin movements caused by blood flow beneath the skin. Image registration module 310 executes any alignment technique suitable for aligning multiple images illuminated under varying lighting conditions.

Normal vector calculator 320 analyzes the multiple captured images of a single skin surface and, for each of the multiple captured images, calculates normal vectors associated with one or more pixels included in the captured image. A normal vector represents the orientation of the skin surface at a particular pixel and includes a vector that originates at the particular pixel and has a direction perpendicular to the skin surface at the particular pixel location.

Normal vector calculator 320 identifies specular reflections in the captured images of the skin surface caused by an oily lipid film covering the skin surface. For each captured image of a single skin surface, normal vector calculator 320 identifies one or more specular pixels included in a captured image that exhibit a brightness that exceeds a predetermined threshold. For each identified specular pixel, normal vector calculator 320 generates a normal vector originating at the identified pixel and having a direction equal to the half-vector between the direction from the pixel to the camera and the direction from the pixel to the light source.

Based on the calculated normal vectors, normal vector calculator 320 generates a sparse collection of normal vectors across all captured images of the single skin sample. Normal vector calculator 320 transmits the sparse collection of normal vectors to map generation module 330.

Map generation module 330 generates a dense displacement map D associated with a single skin sample based on the sparse collection of normal vectors received from normal vector calculator 320. The dense displacement map describes the texture of the skin surface via variations in height and orientation of pixels associated with the generated normal vectors. Map generation module 330 calculates the dense displacement map D via a system of linear equations:

$$\frac{\partial D}{\partial x} = {n}_{x} , normal constraint \qquad ( 1 )$$

$$\frac{\partial D}{\partial y} = {n}_{y} , normal constraint \qquad ( 2 )$$

$$λΔ D = 0 , smoothness constraint \qquad ( 3 )$$

$$D ( c ) = 0 , fix height of the center pixel \qquad ( 4 )$$

where c is the center pixel of the image, nₓ and n_{y} are the observed normal vectors in the x and y directions for a pixel n having an associated normal vector, and λ is a regularization weight. In various embodiments, map generation module 330 may calculate

$$\frac{\partial D}{\partial x} and \frac{\partial DD}{\partial y}$$

via a central differences filter. Map generation module 330 may calculate ΔD via a Laplacian filter having a λ value of 0.001. Map generation module 330 transmits the calculated dense displacement map D to high-pass filter 340.

High-pass filter 340 processes the dense displacement map D received from map generation module 330 via a high-pass filtering technique to remove low-frequency displacement variations from the dense displacement map. Low-frequency displacement variations may include macro-level facial features, such as a contour of a nose, mouth, or eyebrow. Low-frequency displacement variations may also include bulging resulting from the subject's skin being pressed against the cutout window included in skin capture rig 200. High-pass filter 340 preserves high-frequency displacement variations in the dense displacement map, such as pores, fine wrinkles, or other small-scale variations present in the captured skin sample. In various embodiments, the resolution of the dense displacement map may be on the order of 1.5-5.0 microns per pixel.

Capture engine 122 generates an entry in displacement style library 350 based on the high-pass filtered displacement map of the single skin surface and one or more items of metadata associated with the single skin surface. In various embodiments, the associated metadata may include the age or gender of the subject associated with the skin surface. The associated metadata may also include a location associated with the skin surface, such as a forehead, cheek, chin, nose, or temple. Capture engine 122 may repeat the above techniques with additional skin surfaces captured via skin capture rig 200 and generate additional entries in displacement style library 350 associated with the additional captured skin surfaces.

Displacement style library 350 includes one or more entries, where each entry includes a filtered displacement map and associated metadata. As discussed above, the filtered displacement map may include high-frequency, realistic details of a captured skin surface, and the metadata may include an age, gender, or location associated with the skin surface. In various embodiments of the present invention, transfer engine 126 discussed below in the description of FIG. 7 may perform style transfer, where the high-frequency details of one or more displacement maps included in displacement style library 350 are applied to one or more simulated skin surfaces included in a 3D facial reconstruction.

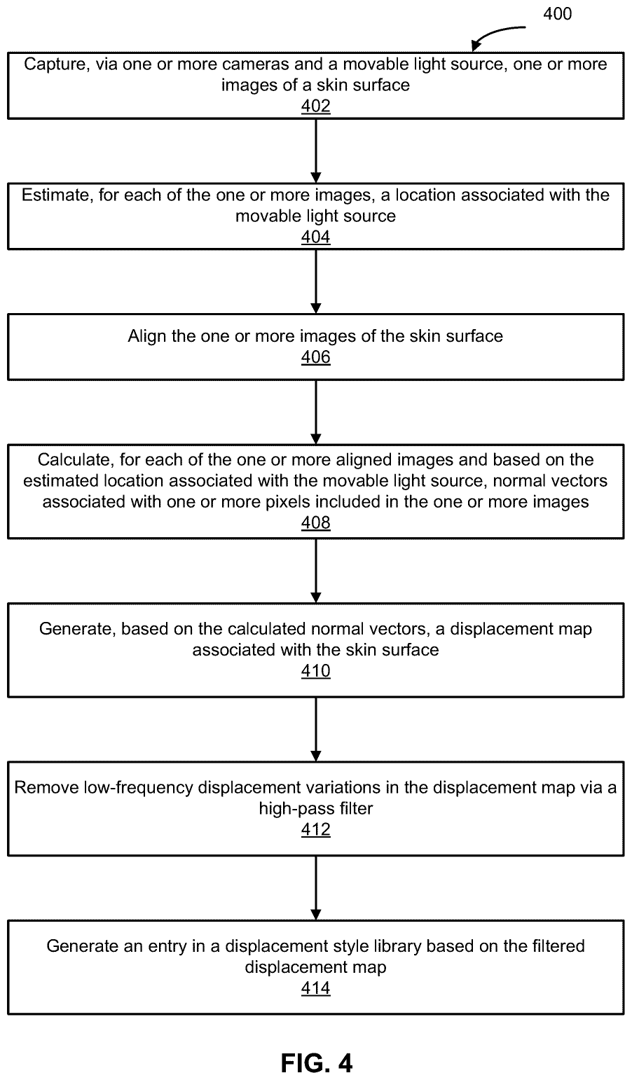

FIG. 4 is a flow diagram of method steps for capturing skin samples, according to some embodiments. Although the method steps are described in conjunction with the systems of FIGS. 1-3, persons skilled in the art will understand that any system configured to perform the method steps in any order falls within the scope of the present disclosure.

As shown, in step 402 of method 400, capture engine 122 records one or more images of a skin surface via skin capture rig 200. As discussed above, skin capture rig 200 includes a vertical planar surface having a window cutout against which a human subject may place a skin surface, such as a temple, chin, or cheek. Skin capture rig 200 also includes a main camera configured to capture an image of the skin surface placed against the window cutout. Skin capture rig 200 further includes a movable light source and two side cameras configured to capture images of two reflective spheres located below and to the left and right sides of the window cutout.

In step 404, capture engine 122 estimates a 3D location associated with the movable light source. In various embodiments, the movable light source may include a handheld flashlight. For each captured image of the skin surface, light estimator 300 analyzes images captured by the two side cameras and associated with the captured image of the skin surface. Light estimator 300 detects reflections of the movable light source present on the reflective spheres and included in the images captured by the side cameras. Light estimator 300 calculates four rays extending from the reflective spheres and converging at or near a location in 3D space. Based on the location at which the light rays converge, light estimator 300 calculates a 3D position associated with the movable light source and the captured image of the skin surface.

In step 406, image registration module 310 of capture engine 122 aligns multiple captured images of a single skin surface recorded by the main camera discussed above. Aligning the captured images reduces spatial inconsistencies between the multiple images caused by subject motion, small skin movements resulting from the subject's breathing, or small skin movements caused by blood flow beneath the skin. Image registration module 310 executes any alignment technique suitable for aligning multiple images illuminated under varying lighting conditions.

In step 408, capture engine 122 calculates, via normal vector calculator 320, normal vectors associated with one or more pixels included in each of the one or more captured images of the skin surface. A normal vector represents the orientation of the skin surface at a particular pixel and includes a vector that originates at the particular pixel and has a direction perpendicular to the skin surface at the particular pixel location.

Normal vector calculator 320 identifies specular reflections in the captured images of the skin surface caused by an oily lipid film covering the skin surface. For each captured image of a single skin surface, normal vector calculator 320 identifies one or more specular pixels included in a captured image that exhibit a brightness that exceeds a predetermined threshold. For each identified specular pixel, normal vector calculator 320 generates a normal vector originating at the identified pixel and having a direction equal to the half-vector between the direction from the identified pixel to the camera and the direction from the identified pixel to the light source. Based on the calculated normal vectors, normal vector calculator 320 generates a sparse collection of normal vectors across all captured images of the single skin surface.

In step 410, capture engine 122 generates, via map generation module 330, a displacement map associated with the captured skin surface. The displacement map describes the texture of the skin surface via variations in height and orientation of pixels associated with the generated normal vectors. In various embodiments, map generation module 330 calculates the height and orientation variations via a linear system of equations (1)-(4) as discussed above in the description of FIG. 3.

In step 412, high-pass filter 340 of capture engine 122 processes the displacement map received from map generation module 330 via a high-pass filtering technique to remove low-frequency displacement variations from the dense displacement map. Low-frequency displacement variations may include macro-level facial features, such as a contour of a nose, mouth, or eyebrow. Low-frequency displacement variations may also include bulging resulting from the subject's skin being pressed against the cutout window included in skin capture rig 200. High-pass filter 340 preserves high-frequency displacement variations in the dense displacement map, such as pores or fine wrinkles present in the captured skin sample.

In step 414, capture engine 122 generates an entry in displacement style library 350 based on the high-pass filtered displacement map of the skin surface and one or more items of metadata associated with the skin surface. In various embodiments, the associated metadata may include the age or gender of the subject associated with the skin surface. The associated metadata may also include a location associated with the skin surface, such as a forehead, cheek, chin, nose, or temple.

Displacement style library 350 includes one or more entries, where each entry includes a filtered displacement map and associated metadata. As discussed above, the filtered displacement map may include high-frequency, realistic details of a captured skin surface, and the metadata may include an age, gender, or location associated with the skin surface. In various embodiments of the present invention, transfer engine 126 discussed below in the description of FIG. 7 may perform style transfer, where the high-frequency details of one or more displacement maps included in displacement style library 350 are applied to one or more simulated skin surfaces included in a 3D facial reconstruction.

Capture engine 122 may repeat the above steps with additional skin surfaces captured via skin capture rig 200 and generate additional entries in displacement style library 350 associated with the additional captured skin surfaces.

FIG. 5 is a more detailed illustration of simulation engine 124 of FIG. 1, according to some embodiments. Simulation engine 124 generates one or more skin textures based on user inputs 520 and preset library 510. Simulation engine 124 interpolates and applies the one or more generated skin textures to a baseline 3D reconstruction 515 to generate modified 3D reconstruction 570. Simulation engine 124 may also generate novel entries in preset library 510 based on displacement style library 350 received from capture engine 122. Simulation engine 124 includes, without limitation, skin simulator 530, classification network 540, generative network 550, and loss calculator 560.

Preset library 510 includes one or more representations of various skin types. In various embodiments, each representation included in preset library 510 may include a visual depiction of the skin type and one or more parameter values associated with the skin type. In various embodiments, the one or more parameter values may include, without limitation, pore depth, pore width, pore distance, or wrinkle directionality. The one or more parameter values, when transmitted to skin simulator 530 described below, cause skin simulator 530 to generate a skin texture displacement map that corresponds to the associated skin type included in preset library 510. In various embodiments, a user may select one or more skin types included in preset library 510 and apply the one or more skin types to one or more regions included in baseline 3D reconstruction 515.

Baseline 3D reconstruction 515 may include a representation of a human face expressed as, e.g., a 3D mesh of triangles or other polygons. The 3D reconstruction may include macro-level details of the face, such as eyes, nose, mouth, or eyebrows.

User inputs 520 include a user-specified selection of one or more skin type presets included in preset library 510. User inputs 520 may also include a user-specified selection of one or more regions included in baseline 3D reconstruction 515. Skin simulator 530 applies the selected skin type presets to the selected regions included in baseline 3D reconstruction 515 and then interpolates the parameter values associated with the one or more skin type presets across the entire surface of baseline 3D reconstruction 515. As discussed above, baseline 3D reconstruction 515 may include a representation of a human face expressed as, e.g., a 3D mesh of triangles or other polygons.

Skin simulator 530 generates simulated skin texture displacement maps and applies the generated skin texture displacement maps to baseline 3D reconstruction 515 to generate modified 3D reconstruction 570. Skin simulator 530 receives user inputs 520, including user selections of one or more regions included in baseline 3D reconstruction 515. Skin simulator 530 also receives one or more user selections of skin type presets included in preset library 510.

Skin simulator 530 associates the one or more selected skin type presets with the corresponding one or more selected regions included in baseline 3D reconstruction 515. Skin simulator 530 interpolates the parameter values associated with the one or more skin types and associates the interpolated parameter values with one or more non-selected regions included in baseline 3D reconstruction 515. For example, a user may select three skin types included in preset library 510 and assign those skin types to the forehead, temple, and chin regions included in baseline 3D reconstruction 515. Skin simulator 530 interpolates the parameter values associated with the skin types assigned to the forehead, temple, and chin regions and generates interpolated parameter values associated with non-selected regions of baseline 3D reconstruction 515, such as cheeks, nose, or lips. After interpolation, baseline 3D reconstruction 515 includes parameter values (assigned or interpolated) associated with all depicted facial regions.

Skin simulator 530 generates skin texture displacement maps for regions included in baseline 3D reconstruction 515 based on the assigned or interpolated parameter values. For each region, skin simulator 530 generates a skin graph including nodes and edges connecting the nodes, where the nodes represent pores, and the edges represent wrinkles. Each wrinkle begins and ends at a pore location. The parameter values associated with a region included in baseline 3D reconstruction 515 may specify physical characteristics of the pores and wrinkles, such as pore spacing, pore depth, pore width, wrinkle orientation, wrinkle width, or wrinkle depth. For each region included in baseline 3D reconstruction 515, skin simulator 530 generates a skin texture displacement map based on the skin graph and the parameter values. Skin simulator 530 generates modified 3D reconstruction 570 and transmits modified 3D reconstruction 570 to simulation engine 124.

Modified 3D reconstruction 570 includes baseline 3D reconstruction 515 as modified by the displacement maps generated by skin simulator 530. The displacement maps represent simulated micro skin details, such as pores and wrinkles, associated with the various facial regions included in modified 3D reconstruction 570. Modified 3D reconstruction 570 may lack the small-scale organic or chaotic variations that characterize real skin. As discussed below in the description of FIG. 7, transfer engine 126 receives modified 3D reconstruction 570 and performs style transfer from the real skin samples captured by capture engine 122 onto one or more regions of modified 3D reconstruction 570. The style transfer introduces realistic organic variations from the real skin samples onto the simulated skin texture displacement maps generated by skin simulator 530 and included in modified 3D reconstruction 570.

In various embodiments, simulation engine 124 is operable to generate novel entries in preset library 510 based on the captured high-resolution skin samples included in displacement style library 350. Generating novel entries in preset library 510 based on captured skin samples provides additional high-quality preset skin types and associated simulator parameters from which a user may choose when selecting preset skin types to apply to baseline 3D reconstruction 515 as described above. Simulation engine 124 generates additional entries in preset library 510 via classification network 540 and generative network 550.

Classification network 540 analyzes a skin texture displacement map included in displacement style library 350 and generates one or more simulator parameters that, when applied to skin simulator 530, cause skin simulator 530 to generate a skin texture displacement map that approximates the analyzed skin texture displacement map. In various embodiments, classification network 540 includes one or more trained machine learning models, such as a convolutional neural network.

Simulation engine 124 may train classification network 540 on a training database (not shown). The training database may include a number, e.g., 50,000, of displacement map/parameter pairs. Each displacement map/parameter pair included in the training database is generated by randomly sampling the parameter space of skin simulator 530 and generating a displacement map via skin simulator 530 based on the randomly sampled parameters. The generated displacement map and associated random parameters form a single displacement map/parameter pair in the training database. Simulation engine 124 iteratively modifies one or more internal weights included in classification network 540 until classification network 540 accurately predicts skin simulator parameters for a given displacement map included in the training database.

After training classification network 540, simulation engine 124 may receive a skin texture displacement map from displacement style library 350 and transmit the skin texture displacement map to classification network 540. Classification network 540 generates initial skin simulator parameters based on the received skin texture displacement map and transmits the skin texture displacement map and initial predicted skin simulator parameters to generative network 550 for additional refinement.

Generative network 550 may include a class-conditioned generative adversarial network that receives a skin texture displacement map and initial predicted skin simulator parameters from classification network 540 and generates one or more refined predicted skin simulator parameters. Generative network 550 generates a skin texture displacement map based on the initial skin simulator parameters received from classification network 540 and transmits the received skin texture displacement map and the generated skin texture displacement map to loss calculator 560.

Loss calculator 560 calculates an adversarial loss function value based on pixel-wise differences between the skin texture displacement map generated by generative network 550 and the received skin texture displacement map. Loss calculator transmits the calculated adversarial loss function value to generative network 550.

Simulation engine 124 modifies one or more skin simulator parameter inputs to generative network 550 based on the adversarial loss function received from loss calculator 560. Simulation engine 124 may iteratively modify the one or more skin simulator parameter inputs and recalculate the skin texture displacement map using generative network 550 based on the calculated adversarial loss function values for a predetermined number of iterations, or until the adversarial loss function is below a predetermined threshold. Simulation engine 124 records the one or more modified skin simulator input parameters and the received skin texture displacement map as a new entry in preset library 510. As discussed above, generating new entries in preset library 510 provides additional, high-quality skin texture displacement maps and associated skin simulator input parameters from which a user may select when applying preset skin textures to baseline 3D reconstruction 515.

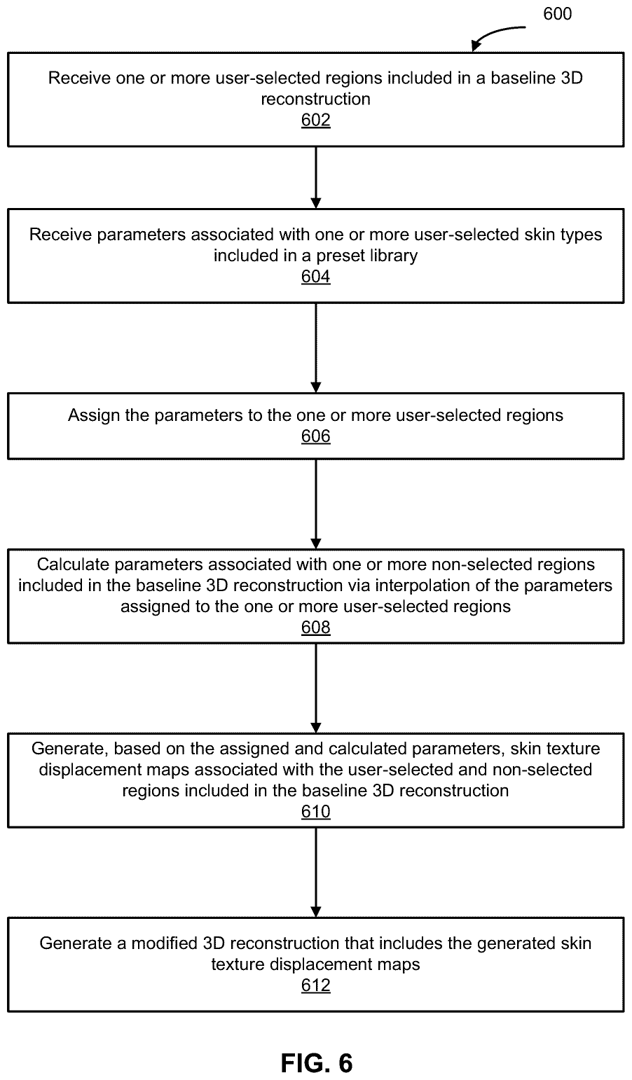

FIG. 6 is a flow diagram of method steps for generating simulated skin textures, according to some embodiments. Although the method steps are described in conjunction with the systems of FIGS. 1-3 and 5, persons skilled in the art will understand that any system configured to perform the method steps in any order falls within the scope of the present disclosure.

As shown, in step 602 of method 600, simulation engine 124 receives one or more user-selected regions included in baseline 3D reconstruction 515. Baseline 3D reconstruction 515 may include a representation of a human face expressed as, e.g., a 3D mesh of triangles or other polygons. Baseline 3D reconstruction 515 may include macro-level details of the face, such as eyes, nose, mouth, or eyebrows.

In step 604, simulation engine 124 receives parameters associated with one or more user-selected skin types included in preset library 510. Each skin type included in preset library 510 may include a visual depiction of the skin type and one or more parameter values associated with the skin type. In various embodiments, the one or more parameter values may include, without limitation pore depth, pore width, pore distance, or wrinkle directionality. The one or more parameter values, when transmitted to skin simulator 530, cause skin simulator 530 to generate a skin texture displacement map that corresponds to the associated skin type included in preset library 510.

In step 606, simulation engine 124 assigns parameter values associated with the one or more user-selected skin types to the one or more user-selected regions included in baseline 3D reconstruction 515. A user may apply a single selected skin type to one or more selected regions included in baseline 3D reconstruction 515.

In step 608, simulation engine 124 calculates parameter values associated with one or more non-selected regions included in baseline 3D reconstruction 515. For example, a user may select three skin types included in preset library 510 and assign those skin types to the forehead, temple, and chin regions included in baseline 3D reconstruction 515. Skin simulator 530 of simulation engine 124 interpolates the parameter values associated with the skin types assigned to the forehead, temple, and chin regions and generates interpolated parameter values associated with non-selected regions of baseline 3D reconstruction 515, such as cheeks, nose, or lips. After interpolation, baseline 3D reconstruction 515 includes parameter values (assigned or interpolated) associated with all depicted facial regions.

In step 610, skin simulator 530 of simulation engine 124 generates skin texture displacement maps associated with the user-selected and non-selected regions included in baseline 3D reconstruction 515. For each region included in baseline 3D reconstruction 515, skin simulator 530 generates a skin graph including nodes and edges connecting the nodes, where the nodes represent pores, and the edges represent wrinkles. Each wrinkle begins and ends at a pore location. The parameter values associated with a region included in baseline 3D reconstruction 515 may specify physical characteristics of the pores and wrinkles, such as pore spacing, pore depth, pore width, wrinkle orientation, wrinkle width, or wrinkle depth. For each region included in baseline 3D reconstruction 515, skin simulator 530 generates a skin texture displacement map based on the skin graph and the parameter values.

In step 612, simulation engine 124 generates modified 3D reconstruction 570 that includes baseline 3D reconstruction 515 as modified with the generated skin texture displacement maps associated with each of the one or more regions included in baseline 3D reconstruction 515. The generated skin texture displacement maps represent simulated skin textures, and may include facial macro details, such as a nose, mouth, or eyebrows, as well as micro details, such as pores and wrinkles.

FIG. 7 is a more detailed illustration of transfer engine 126 of FIG. 1, according to some embodiments. Transfer engine 126 applies one or more high-resolution skin texture displacement maps included in displacement style library 350 to one or more user-selected regions of modified 3D reconstruction 570. Transfer engine 126 transfers the high-frequency details included in the one or more high-resolution skin texture displacement maps onto the structural content included in the one or more user-selected regions of modified 3D reconstruction 570. The high-frequency details may include realistic, natural-looking organic variations in skin texture that may be absent in modified 3D reconstruction 570. Transfer engine 126 includes, without limitation, patch generator 710, stylizing module 720, stylized output 730, and blending module 740.

Patch generator 710 divides the surface of modified 3D reconstruction 570 into multiple patches, where each patch is associated with a contiguous region of pixels included in modified 3D reconstruction 570. In various embodiments, each of the multiple patches may overlap one or more adjacent patches by a predetermined number of pixels, e.g., fifty pixels. Patch generator 710 may also feather the edges of the multiple patches to reduce the appearance of distinct boundaries between adjacent patches. Patch generator 710 may divide the surface of modified 3D reconstruction 570 into a predetermined number of patches, or may receive a user-specified number of patches via user inputs 520. Patch generator 710 transmits modified 3D reconstruction 570 and the associated patches to stylizing module 720.

Stylizing module 720 transfers high-frequency style elements from a skin texture displacement map included in displacement style library 350 onto one or more regions of modified 3D reconstruction 570, where each of the one or more regions is associated with a patch generated by patch generator 710. A user may select a specific skin texture displacement map included in displacement style library 350 and a specific patch generated by patch generator 710. The user selections are transmitted to transfer engine 126 via user inputs 520.

Stylizing module 720 receives modified 3D reconstruction 570 and one or more patches associated with modified 3D reconstruction 570 from patch generator 710. Stylizing module 720 also receives, via user inputs 520, user selections designating or more patches associated with modified 3D reconstruction 570 and a user selection designating an entry in displacement style library 350. Stylizing module 720 applies stylistic features included in the skin texture displacement map to structural content included in the one or more patches. The structural content may include skin micro features, such as pores or wrinkles. The stylistic features may include realistic high-frequency skin texture variations present in the skin texture displacement maps included in displacement style library 350.

Stylizing module 720 includes one or more machine learning models, such as convolutional neural networks or generative adversarial networks. In various embodiments, each of the one or more machine learning models is previously trained to perform style transfer from a different one of the skin texture displacement maps included in displacement style library 350 onto a provided content image, such as a patch included in modified 3D reconstruction 570. The one or more machine learning models preserve both the structure from the patch included in modified 3D reconstruction 570 and the high-frequency textural features present in a skin texture displacement map included in displacement style library 350.

Based on user input 520, stylizing module 720 may perform style transfer from a single selected skin texture displacement map included in displacement style library 350 entry onto one or more user-selected patches associated with regions included in modified 3D reconstruction 570. A user may repeatedly select patches and skin texture displacement maps until stylizing module 720 has transferred stylistic elements onto all or a selected subset of patches included in modified 3D reconstruction 570. After stylizing module 720 has completed style transfer onto all of the patches or the selected subset of patches, stylizing module 720 generates stylized output 730.

Stylized output 730 includes modified 3D reconstruction 570 as modified by patch generator 710 and stylizing module 720. Specifically, stylized output 730 includes a 3D mesh facial reconstruction with simulated skin features generated by simulation engine 124 and high-frequency stylistic elements transferred onto the simulated skin features by stylizing module 720, based on one or more user-specified skin texture displacement maps included in displacement style library 350. Transfer engine 126 transmits stylized output 730 to blending module 740.

Blending module 740 adjusts the effects of the style transfer technique described above based on a user-controllable blending factor included in user inputs 520. Blending module 740 receives modified 3D reconstruction 570, stylized output 730, and the user-controllable blending factor. Blending module 740 generates final 3D reconstruction 210 based on a weighted combination of modified 3D reconstruction 570 and stylized output 730. For example, the user-controllable blending factor may have a range of values from 0 to 1, where a blending factor of 0 may cause blending module 740 to generate a final 3D reconstruction 210 that is identical to modified 3D reconstruction 570, with no style transfer effects applied. A blending factor of 1 may cause blending module 740 to generate a final 3D reconstruction 210 that is identical to stylized output 730 generated by stylizing module 720. A blending factor of between 0 and 1 may cause blending module 740 to generate a final 3D reconstruction 210 that exhibits the high-frequency style transfer effects generated by stylizing module 720 to a lesser degree than stylized output 730, with the degree of style transfer effects determined by the value of the blending factor.

As described above, final 3D reconstruction 210 includes baseline 3D reconstruction 515 as modified by simulation engine 124 and transfer engine 126 to include simulated skin textures that are further augmented with high-frequency skin texture features from one or more entries included in displacement style library 350. Final 3D reconstruction 210 includes simulated facial micro details such as pores and wrinkles, as well as realistic organic skin variations introduced by the style transfer techniques described above.

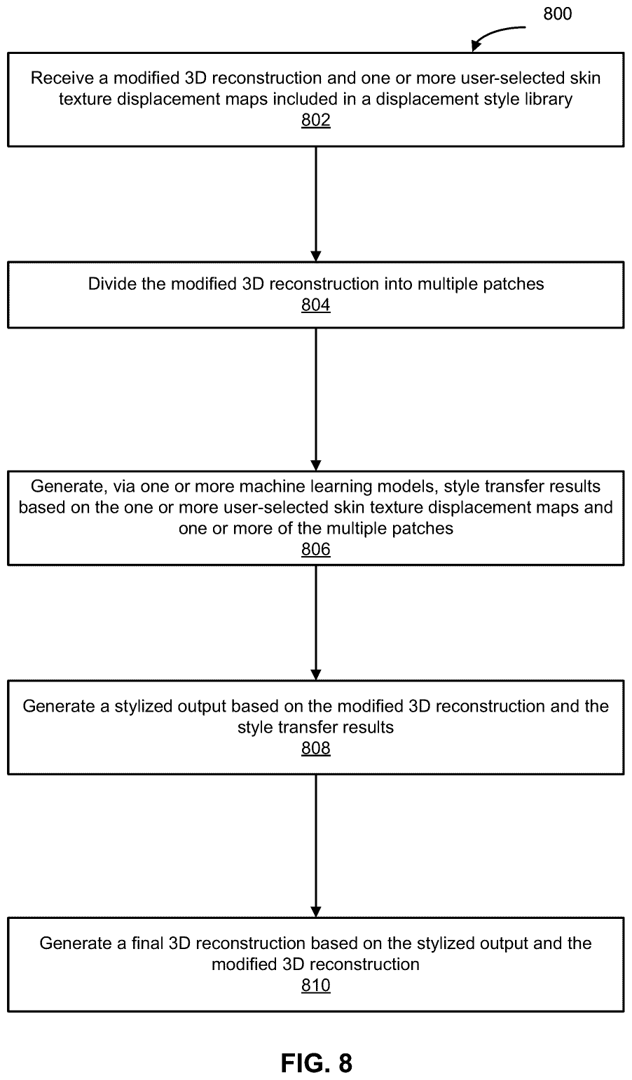

FIG. 8 is a flow diagram of method steps for performing style transfer, according to some embodiments. Although the method steps are described in conjunction with the systems of FIGS. 1-3, 5, and 7, persons skilled in the art will understand that any system configured to perform the method steps in any order falls within the scope of the present disclosure.

As shown, in step 802 of method 800, transfer engine 126 receives modified 3D reconstruction 570 and one or more user selections of skin texture displacement maps included in displacement style library 350. As discussed above, modified 3D reconstruction 570 includes a 3D mesh representation of a face and various skin texture displacement maps associated with multiple regions included in modified 3D reconstruction 570. Each entry included in displacement style library 350 includes a filtered displacement map and associated metadata. The filtered displacement map may include high-frequency, realistic details of a captured skin surface, and the metadata may include an age, gender, or location associated with the skin surface.

In step 804, patch generator 710 of transfer engine 126 divides the surface of modified 3D reconstruction 570 into multiple patches, where each patch is associated with a contiguous region of pixels included in modified 3D reconstruction 570. In various embodiments, each of the multiple patches may overlap one or more adjacent patches by a predetermined number of pixels, e.g., fifty pixels. Patch generator 710 may also feather the edges of the multiple patches to reduce the appearance of distinct boundaries between adjacent patches. Patch generator 710 may divide the surface of modified 3D reconstruction 570 into a predetermined number of patches, or may receive a user-specified number of patches via user inputs 520.

In step 806, stylizing module 720 of transfer engine 126 transfers high-frequency stylistic elements from a skin texture displacement map included in displacement style library 350 onto one or more regions of modified 3D reconstruction 570, where each of the one or more regions is associated with a patch generated by patch generator 710.

Stylizing module 720 receives modified 3D reconstruction 570 and one or more patches associated with modified 3D reconstruction 570 from patch generator 710. Stylizing module 720 also receives, via user inputs 520, user selections designating or more patches associated with modified 3D reconstruction 570 and a user selection designating an entry in displacement style library 350. Stylizing module 720 applies stylistic features included in the displacement style library 350 entry to structural content included in the one or more patches. The structural content may include skin micro features, such as pores or wrinkles. The stylistic features may include realistic high-frequency skin texture variations present in the skin texture displacement maps included in displacement style library 350.

Stylizing module 720 includes one or more machine learning models, such as convolutional neural networks or generative adversarial networks. In various embodiments, each of the one or more machine learning models is previously trained to perform style transfer from a different skin texture displacement map included in displacement style library 350 onto a provided content image, such as a patch included in modified 3D reconstruction 570. The one or more machine learning models preserve both the structure from the patch included in modified 3D reconstruction 570 and the high-frequency textural features present in the skin texture displacement map included in displacement style library 350.

Based on user input 520, stylizing module 720 may perform style transfer from a single selected skin texture displacement map included in displacement style library 350 onto one or more user-selected patches associated with regions included in modified 3D reconstruction 570. A user may repeatedly select entries from displacement style library 350 based on visual depictions or metadata associated with the entries. The user may also select one or more patches included in modified 3D reconstruction 570 until stylizing module 720 has transferred stylistic elements onto all or a selected subset of patches included in modified 3D reconstruction 570.

In step 808, after stylizing module 720 has transferred stylistic elements onto all or a selected subset of patches included in modified 3D reconstruction 570, stylizing module generates stylized output 730. Stylized output 730 includes a 3D mesh facial reconstruction with simulated skin features generated by simulation engine 124 and high-frequency stylistic elements transferred onto the simulated skin features by stylizing module 720, based on one or more user-specified skin texture displacement maps included in displacement style library 350.

In step 810, blending module 740 of transfer engine 126 generates final 3D reconstruction 210 based on a weighted combination of modified 3D reconstruction 570 and stylized output 730. For example, a user-controllable blending factor may have a range of values from 0 to 1, where a blending factor of 0 may cause blending module 740 to generate a final 3D reconstruction 210 that is identical to modified 3D reconstruction 570 with no style transfer effects applied. A blending factor of 1 may cause blending module 740 to generate a final 3D reconstruction 210 that is identical to stylized output 730 generated by stylizing module 720. A blending factor of between 0 and 1 may cause blending module 740 to generate a final 3D reconstruction 210 that exhibits the high-frequency style transfer effects generated by stylizing module 720 to a lesser degree than stylized output 730, with the degree of style transfer effects determined by the value of the blending factor.

As described above, final 3D reconstruction 210 includes baseline 3D reconstruction 515 as modified by simulation engine 124 and transfer engine 126 to include simulated skin textures that are further augmented with high-frequency skin texture features from one or more entries included in displacement style library 350. Final 3D reconstruction 210 includes simulated facial micro details such as pores and wrinkles, as well as realistic organic skin variations introduced by the style transfer techniques described above.

In sum, the disclosed techniques perform face micro detail recovery by simulating a skin texture and applying style transfer from one or more high-resolution scanned skin samples onto the simulated skin texture. When simulating the skin texture, a user may select from a library of preset simulation parameters which are then interpolated over an entire 3D facial representation. The techniques may also expand the library of preset simulation parameters based on the one or more high-resolution scanned skin samples. The disclosed techniques generate a full-face displacement map of macro- and micro-level textures with the organic appearance of real skin, obtained in a user-controllable manner.

In operation, a capture engine may record one or more skin samples from a human subject via a skin capture rig. The skin capture rig includes a vertical planar surface with a small (e.g., 2 cm×2 cm) window cutout, multiple fixed cameras, multiple reflective spheres, and a single movable light source. On one side of the vertical planar surface, the human subject places a portion of their face, such as a cheek, forehead, chin, or temple against the window cutout. On the other side of the vertical planar surface, a main camera is positioned to capture the portion of the subject's face that is placed against the window cutout. Each of two side cameras positioned to the left and right of the main camera capture two reflective spheres located on the vertical planar surface below and to the sides of the window cutout. A movable light source, e.g. a handheld flashlight, is positioned to illuminate the portion of the subject's face that is placed against the window cutout. During skin capture, the movable light source is repositioned to illuminate the portion of the subject's face from multiple angles, and for each illumination angle, the main and side cameras capture the portion of the subjects face and the reflective spheres. The main camera captures the portion of the subject's face at a high resolution, e.g., 1.5-5.0 microns per pixel. The capture engine analyzes the captured images of the reflective spheres and estimates a position of the movable light associated with a captured image of the subject's skin. The capture engine calculates a normal vector associated with one or more pixels included in the captured image of the subject's skin, based on the estimated light position. For a single portion of the subject's face, the capture engine may record a number of exposures, e.g. thirty, with varying lighting positions. For each exposure, the capture engine generates a displacement map representing the captured skin sample, including facial micro details such as pores and/or wrinkles. The generated displacement maps inform the skin simulation and style transfer techniques described below.

A simulation engine receives a baseline 3D reconstruction of a face and generates skin texture patterns for various regions of the 3D baseline reconstruction. The simulation engine includes a skin simulator and a preset library, where each entry in the preset library includes multiple simulator parameters that, when processed by the skin simulator, generate one of a variety of skin textures. The simulation engine may also generate new entries in the preset library based on the high-resolution displacement maps generated by the capture engine. For each displacement map generated by the capture engine, the simulation engine analyzes the displacement map and predicts simulator parameters that, when processed by the skin simulator, generate a skin texture based on the displacement map.

A user may select one or more skin types included in the preset library and interactively place the selected skin types at one or more regions of the baseline 3D reconstruction. The simulation engine interpolates the simulator parameters included in the one or more selected skin types across the entire baseline 3D reconstruction. The simulation engine then generates a modified 3D reconstruction that includes face-wide micro details based on the interpolation of the one or more selected skin types.

The modified 3D reconstruction generated by the simulation engine includes facial micro details, but may lack the high-frequency details or the organic/chaotic variations characteristic of natural skin. A transfer engine further modifies the 3D reconstruction via style transfer, where fine details included in the high-resolution displacement maps generated by the capture engine are transferred onto different regions included in the 3D reconstruction. A user may select one or more high-resolution displacement maps and one or more regions of the 3D reconstruction. The transfer engine modifies the selected regions of the 3D reconstruction based on the selected displacement maps, such that fine details and variations included in the selected displacement map are applied to the micro details included in the 3D reconstruction. The transfer engine generates a final 3D reconstruction that includes skin features(s) generated by the simulation engine as modified with the fine details and organic/chaotic variations transferred from the high-resolution displacement maps generated by the capture engine.

One technical advantage of the disclosed techniques relative to the prior art is that the disclosed techniques simultaneously provide both artistically controllable skin simulation and realistic, organic results based on style transfer from high-resolution captures of actual skin samples onto the simulated skin features. Further, the disclosed techniques are operable to capture skin samples via a simple and inexpensive camera-based scanning apparatus. These technical advantages provide one or more improvements over prior art approaches.
1. In some embodiments, a computer-implemented method for performing face micro detail recovery, the computer-implemented method comprises generating one or more skin texture displacement maps based on images of one or more skin surfaces, transferring, via one or more machine learning models, stylistic elements included in the one or more skin texture displacement maps onto one or more regions included in a modified three-dimensional (3D) facial reconstruction, and generating a final 3D facial reconstruction that includes structural elements included in the 3D facial reconstruction and the stylistic elements included in the one or more skin texture displacement maps.
2. The computer-implemented method of clause 1, wherein the modified 3D facial reconstruction includes one or more simulated skin textures.
3. The computer-implemented method of clauses 1 or 2, wherein the structural elements include one or more pores and one or more wrinkles.
4. The computer-implemented method of any of clauses 1-3, wherein the stylistic elements include one or more skin texture variations defined by the one or more skin texture displacement maps.
5. The computer-implemented method of any of clauses 1-4, wherein generating the final 3D facial reconstruction is based at least on the modified 3D facial reconstruction and a user-controllable blending factor.
6. The computer-implemented method of any of clauses 1-5, further comprising receiving user input defining a correspondence between one of the one or more skin texture displacement maps and at least one of the one or more regions.
7. The computer-implemented method of any of clauses 1-6, wherein the modified 3D facial reconstruction includes a 3D mesh of triangles or other polygons.
8. The computer-implemented method of any of clauses 1-7, wherein each of the one or more machine learning models includes a convolutional neural network or a generative adversarial network.
9. The computer-implemented method of any of clauses 1-8, wherein the modified 3D facial reconstruction includes depictions of one or more of a mouth, a nose, eyes, or eyebrows.
10. In some embodiments, one or more non-transitory computer-readable media store instructions that, when executed by one or more processors, cause the one or more processors to perform the steps of generating one or more skin texture displacement maps based on images of one or more skin surfaces, transferring, via one or more machine learning models, stylistic elements included in the one or more skin texture displacement maps onto one or more regions included in a modified three-dimensional (3D) facial reconstruction, and generating a final 3D facial reconstruction that includes structural elements included in the 3D facial reconstruction and the stylistic elements included in the one or more skin texture displacement maps.
11. The one or more non-transitory computer-readable media of clause 10, wherein the modified 3D facial reconstruction includes one or more simulated skin textures.
12. The one or more non-transitory computer-readable media of clauses 10 or 11, wherein the structural elements include one or more pores and one or more wrinkles.
13. The one or more non-transitory computer-readable media of any of clauses 10-12, wherein the stylistic elements include one or more skin texture variations defined by the one or more skin texture displacement maps.
14. The one or more non-transitory computer-readable media of any of clauses 10-13, wherein generating the final 3D facial reconstruction is based at least on the modified 3D facial reconstruction and a user-controllable blending factor.
15. The one or more non-transitory computer-readable media of any of clauses 10-14, wherein the instructions further cause the one or more processors to perform the step of receiving user input defining a correspondence between one of the one or more skin texture displacement maps and at least one of the one or more regions.
16. The one or more non-transitory computer-readable media of any of clauses 10-15, wherein the modified 3D facial reconstruction includes a 3D mesh of triangles or other polygons.
17. The one or more non-transitory computer-readable media of any of clauses 10-16, wherein each of the one or more machine learning models includes a convolutional neural network or a generative adversarial network.
18. The one or more non-transitory computer-readable media of any of clauses 10-17, wherein the modified 3D facial reconstruction includes depictions of one or more of a mouth, a nose, eyes, or eyebrows.
19. In some embodiments, a system comprises one or more memories storing instructions, and one or more processors for executing the instructions to generate one or more skin texture displacement maps based on images of one or more skin surfaces, transfer, via one or more machine learning models, stylistic elements included in the one or more skin texture displacement maps onto one or more regions included in a modified three-dimensional (3D) facial reconstruction, and generate a final 3D facial reconstruction that includes structural elements included in the 3D facial reconstruction and the stylistic elements included in the one or more skin texture displacement maps.
20. The system of clause 19, wherein the stylistic elements include one or more skin texture variations defined by the one or more skin texture displacement maps.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing face micro detail recovery, the computer-implemented method comprising:
generating one or more skin texture displacement maps based on images of one or more skin surfaces;
transferring, via one or more machine learning models, stylistic elements included in the one or more skin texture displacement maps onto one or more regions included in a modified three-dimensional (3D) facial reconstruction; and
generating a final 3D facial reconstruction that includes structural elements included in the 3D facial reconstruction and the stylistic elements included in the one or more skin texture displacement maps.

2. The computer-implemented method of claim 1, wherein the modified 3D facial reconstruction includes one or more simulated skin textures.

3. The computer-implemented method of claim 1, wherein the structural elements include one or more pores and one or more wrinkles.

4. The computer-implemented method of claim 1, wherein the stylistic elements include one or more skin texture variations defined by the one or more skin texture displacement maps.

5. The computer-implemented method of claim 1, wherein generating the final 3D facial reconstruction is based at least on the modified 3D facial reconstruction and a user-controllable blending factor.

6. The computer-implemented method of claim 1, further comprising receiving user input defining a correspondence between one of the one or more skin texture displacement maps and at least one of the one or more regions.

7. The computer-implemented method of claim 1, wherein the modified 3D facial reconstruction includes a 3D mesh of triangles or other polygons.

8. The computer-implemented method of claim 1, wherein each of the one or more machine learning models includes a convolutional neural network or a generative adversarial network.

9. The computer-implemented method of claim 1, wherein the modified 3D facial reconstruction includes depictions of one or more of a mouth, a nose, eyes, or eyebrows.

10. One or more non-transitory computer-readable media storing instructions that, when executed by one or more processors, cause the one or more processors to perform the steps of:
generating one or more skin texture displacement maps based on images of one or more skin surfaces;
transferring, via one or more machine learning models, stylistic elements included in the one or more skin texture displacement maps onto one or more regions included in a modified three-dimensional (3D) facial reconstruction; and
generating a final 3D facial reconstruction that includes structural elements included in the 3D facial reconstruction and the stylistic elements included in the one or more skin texture displacement maps.

11. The one or more non-transitory computer-readable media of claim 10, wherein the modified 3D facial reconstruction includes one or more simulated skin textures.

12. The one or more non-transitory computer-readable media of claim 10, wherein the structural elements include one or more pores and one or more wrinkles.

13. The one or more non-transitory computer-readable media of claim 10, wherein the stylistic elements include one or more skin texture variations defined by the one or more skin texture displacement maps.

14. The one or more non-transitory computer-readable media of claim 10, wherein generating the final 3D facial reconstruction is based at least on the modified 3D facial reconstruction and a user-controllable blending factor.

15. The one or more non-transitory computer-readable media of claim 10, wherein the instructions further cause the one or more processors to perform the step of receiving user input defining a correspondence between one of the one or more skin texture displacement maps and at least one of the one or more regions.

16. The one or more non-transitory computer-readable media of claim 10, wherein the modified 3D facial reconstruction includes a 3D mesh of triangles or other polygons.

17. The one or more non-transitory computer-readable media of claim 10, wherein each of the one or more machine learning models includes a convolutional neural network or a generative adversarial network.

18. The one or more non-transitory computer-readable media of claim 10, wherein the modified 3D facial reconstruction includes depictions of one or more of a mouth, a nose, eyes, or eyebrows.

19. A system comprising:
one or more memories storing instructions; and
one or more processors for executing the instructions to:
generate one or more skin texture displacement maps based on images of one or more skin surfaces;
transfer, via one or more machine learning models, stylistic elements included in the one or more skin texture displacement maps onto one or more regions included in a modified three-dimensional (3D) facial reconstruction; and
generate a final 3D facial reconstruction that includes structural elements included in the 3D facial reconstruction and the stylistic elements included in the one or more skin texture displacement maps.

20. The system of claim 19, wherein the stylistic elements include one or more skin texture variations defined by the one or more skin texture displacement maps.
